(19) United States
(12) Patent Application Publication
(10) Pub. No.: US 2014/0117809 A1
(43) Pub. Date: May 1, 2014

(54) CMUT Array

(71) Applicant: The Governors of the University of Alberta, Edmonton (CA)

(72) Inventor: Roger Zemp, Edmonton (CA)

(73) Assignee: The Governors of the University of Alberta, Edmonton (CA)

(21) Appl. No.: 14/059,078

(22) Filed: Oct. 21, 2013

Related U.S. Application Data
(60) Provisional application No. 61/716,205, filed on Oct. 19, 2012.

(30) Foreign Application Priority Data
Oct. 19, 2012 (CA) 2795441

(51) Int. Cl. H02N 11/00

(52) U.S. Cl. CPC H02N 11/002
USPC 310/308

(57) ABSTRACT

Novel CMUT architectures are provided permitting independent addressability of both top and bottom CMUT electrodes. CMUT top electrodes are connected in strips along the x-direction, while CMUT bottom electrodes are connected in strips along the y-direction. In an embodiment, 3D imaging can be performed with an N×N 2D array using only N transmit channels and N receive channels.

### CROSS-REFERENCE TO RELATED APPLICATIONS

This application claims the benefit under 35 USC 119(e) of U.S. provisional application Ser. No. 61/716,205 filed Oct. 19, 2012.

### TECHNICAL FIELD

CMUT Arrays.

### BACKGROUND

Capacitive micromachined ultrasound transducers (CMUTs) offer many potential advantages over piezoelectric transducers, and hold promise for cost-effective 2D arrays. Fully-wired 2D arrays are cost-prohibitive due to large channel counts. A common difficulty in implementing 2D arrays for 3D ultrasound imaging is the problem of large channel counts. A fully-wired array of N×N elements would require N² transmit/receive channels, introducing significant system complexity and cost, especially if N is large. Fabrication and interconnect schemes are non-trivial. Capacitive micromachined ultrasound transducers (CMUTs) are miniature membrane structures typically manufactured on silicon wafers using microfabrication technology. They offer a natural solution for 3D imaging, and provide a number of potential advantages over traditional piezoelectric transducer materials including inherently broadband immersion operation for tissue imaging, exceptional sensitivity, and potential for improved mass fabrication and integration with on-chip high-density electronics. Systems with sufficient portability and reduced cost could revolutionize the medical practice. Despite these potential advantages, the problems of system complexity still exist for CMUTs.

Many CMUT designs use a bottom doped wafer as a common ground-plane, while metalized top membranes serve as signal electrodes. Others use the top membrane as the ground plane, however, provide no way of electrically addressing bottom electrodes. These architectures are not amenable to the low-channel-count imaging schemes we propose. We recently presented a double-SOI wafer-bonded (D-SOI-WB) architecture similar to that of Kupnik et al, presented at the same conference. This architecture permits top electrodes to be routed and connected independent of the bottom electrode routing and connection schemes.

### SUMMARY

There is provided an ultrasound array comprising plural capacitive micromachined ultrasound transducers (CMUTs), each CMUT having a top electrode and a bottom electrode, the respective top electrodes of the CMUTs being connected in plural top electrode strips (TES), and the respective bottom electrodes of the CMUTs being connected in plural bottom electrode strips (BES), the BES being oriented at an angle to the TES, the angle being substantially different from zero; transmit electronics connected to the TES or BES; and receive electronics connected to the TES or BES.

There is provided in a further embodiment an ultrasound array comprising plural ultrasound transducers, each ultrasound transducer having a top electrode and a bottom electrode, the respective top electrodes of the ultrasound transducers being connected in plural top electrode strips (TES), and the respective bottom electrodes of the ultrasound transducers being connected in plural bottom electrode strips (BES), the BES being oriented at an angle to the TES, the angle being substantially different from zero; control electronics connected to the BES or to the TES, the control electronics controlling the response of the ultrasound transducers; and transmit electronics and transmit electronics connected to the other of the TES or BES.

In various embodiments, there may be included any one or more of the following features: the ultrasound transducers may be capacitive micromachined ultrasound transducers; and the control electronics may control the response of the ultrasound transducers by controlling bias and or modulation voltages.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a sequence of side views (a)-(l) showing a patterned-SOI sacrificial-release process (P-SOI-SR) fabrication process;

FIG. 2 is a perspective view showing the TOBE 2D CMUT array structure;

FIG. 3 is a schematic diagram showing a first imaging scheme (Imaging Scheme 1). Top electrode serves as ground and routes receive signals to an amplifier. The diode pair prevents voltages greater than 0.7V from existing between the CMUT and a patient.

FIG. 4 is a schematic diagram showing Orthogonal One-way Dynamic Transmit-Receive Focusing (O1-DTRF). DRBF: Dynamic Receive Beamforming. Tx: Transmit. Rx: Receive.

FIG. 5 is a schematic diagram showing a second imaging scheme (Imaging Scheme 2). Top electrodes route transmit (Tx) and receive (Rx) signal, while the bottom electrode serves as bias voltage control. The response of the CMUT with a bias voltage is significantly greater (˜9×) that when no bias voltage is used.

FIG. 6. is a schematic diagram showing a method to use scheme 2 for single element control.

FIG. 7 is a schematic diagram showing Orthogonal 2-Way Dynamic Transmit-Receive Focusing using Scheme 2.

FIG. 8 is a graph showing Cross-Range-Maximum-Amplitude point-spread function plots comparing imaging schemes 1 and 2 on a log-scale.

### DETAILED DESCRIPTION

The 2D array designs we propose may be implemented using a D-SOI-WB architecture, or other possible architectures. We present one possible embodiment, based on a modified sacrificial release fabrication scheme: one using a patterned SOI wafer with doped device-layer serving as bottom electrode.

TOBE 2D CMUT arrays permit 3D ultrasound imaging using N transmit channels and N receive channels rather than N² transmit/receive channels. Two imaging schemes are described presently. Scheme 1 permits 3D image formation with only N transmit events, but provides only one-way focusing, whereas Scheme 2 permits 2-way focusing but requires N² transmit events, similar to mechanically-wobbled linear arrays, but without the need for mechanical scanning Scheme 1 permits the top electrode to serve as ground (beneficial for patient safety) but this is not possible in Scheme 2 in the present embodiment, hence a passivation layer would be required. We believe that TOBE CMUTs offer significant promise for high-density 2D ultrasound arrays. Besides the imaging schemes presented here numerous other possible imaging schemes are possible using proposed transducer architectures and interfacing schemes as would be understood by a person of average skill in the art.

Capacitive micromachined ultrasound transducers (CMUTs) offer many potential advantages over piezoelectric transducers, and hold promise for cost-effective 2D arrays. Fully-wired 2D arrays are cost-prohibitive due to large channel counts. We present what we call Top-Orthogonal-to-Bottom Electrode (TOBE) 2D CMUT arrays with the potential to perform 3D imaging with an N×N 2D array using only N transmit channels and N receive channels. Candidate fabrication technologies are discussed and a modified sacrificial release process is used to fabricate a prototype. Performance of two imaging schemes is discussed.

Here we present a novel CMUT architecture along with some potential schemes to implement 3D imaging with only N transmit channels and N receive channels. We use novel CMUT architectures permitting independent addressability of both top and bottom CMUT electrodes. CMUT top electrodes are connected in strips along the x-direction, while CMUT bottom electrodes are connected in strips along the y-direction. With this architecture, different 3D imaging schemes are proposed, simulated, and discussed. Simple devices are tested to demonstrate proof of principle.

CMUT Architectures and Fabrication

Key novel aspect of the CMUT architectures we will present include (1) top electrodes being addressable and connected separately and independently from bottom electrodes, which have their own connectivity. (2) Top electrodes are connected in strips, with bottom electrodes connected in strips in the orthogonal direction from top electrode strips. We recently presented a double-SOI wafer-bonded (D-SOI-WB) architecture similar to that of Kupnik et al, presented at the same conference. This architecture permits top electrodes to be routed and connected independent of the bottom electrode routing and connection schemes. The 2D array designs we present may be implemented using this double-SOI CMUT architecture. We also present for the first time to our knowledge an alternate architecture, based on a modified sacrificial release fabrication scheme: one using a patterned SOI wafer with doped device-layer serving as bottom electrode. We will call this process our patterned-SOI sacrificial-release process (P-SOI-SR). In either process (D-SOI-WB or P-SOI-SR), top electrodes may be connected in strips which are orthogonal to bottom electrode strips. Alternate fabrication schemes are possible to realize embodiments of the TOBE architecture described here as would be understood by a person of average skill in the art.

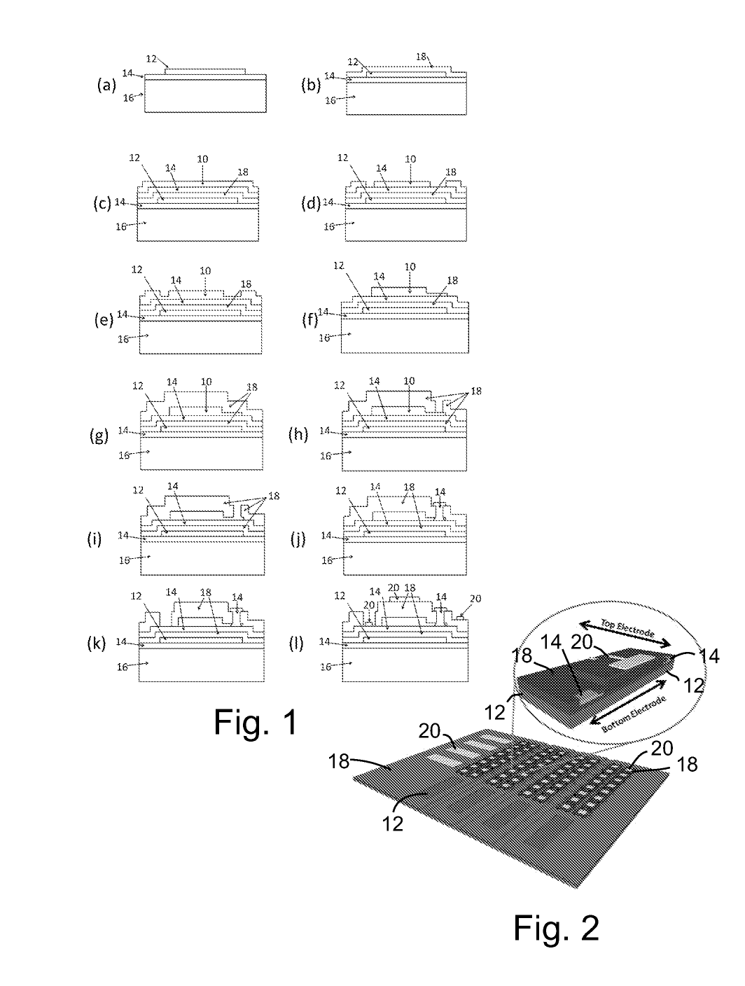

FIG. 1 shows the P-SOI-SR fabrication scheme. In FIG. 1 (a)-(l), the process is shown using the materials PolySi 10, heavily boron doped silicon 12, SiO₂ 14, silicon 16, Si₃N_{4 18,} and aluminum 20. An SOI wafer with boron-doped device layer is patterned using high etch-rate (up to 32 μm/min) inductively-coupled plasma deep reactive etching (ICP-DRIE) (Alcatel AMS200) in (a) to define bottom electrodes with the buried oxide (BOX) layer serving as an etch-stop. Then LPCVD nitride is deposited in (b) as a bottom dielectric layer and KOH-etch-stop. LPCVD oxide is next deposited in (c) and will act as an etch-stop layer for ICP-RIE etching of the nitride layers. LPCVD PolySi is next deposited in (c) as a sacrificial layer. This is patterned to define the gap-area in (d). Another LPCVD PolySi deposition in (e) and patterning step (f) provides definition of low-height etching channels, while slightly increasing the height of the sacrificial PolySi in the gap area. BOE etching is performed in (f) to remove the oxide layer in all areas except directly below the gap and etching-channel PolySi areas. This is done so that when nitride top membranes are deposited in (g), the nitride will act as a KOH etch-stop layer. If this BOE step were not performed KOH etching could slowly etch the oxide layer and thus slowly erode the CMUT sidewalls to a larger than desired extent. On the other hand, if the oxide layer were not present, there would be no ICP-DRIE etch-stop layer, and over-etching into the bottom SOI wafer could be catastrophic.

For the top membrane structural material a sandwich structure is proposed: a few nm of stoichiometric Si3N4 then a thick layer of low-stress (<100 MPa) LPCVD nitride, then a final few nm of stoichiometric Si3N4. The KOH etch selectivity between polySi (fast etching) and nitride (negligible etching) is higher for stoichiometric compared to low-stress nitride with our films, and these thin layers will not significantly add to the membrane stress. High etch-selectivity is important because our membranes can be larger than 100 microns across for low-frequency devices, and erosion of the nitride material could be catastrophic if KOH etch-selectivity were low. After sandwich nitride layers are deposited in (g), then sacrificial etching holes are formed (h) in the nitride layers down to the oxide etch-stop layer using ICP-DRIE. Sacrificial etching is next performed in (i) using KOH wet-etching until membranes are released. Although the etch-rate of oxide is much slower than PolySi, the oxide layer beneath the gap and etch-channel areas will be completely etched away during the long sacrificial etches. There is danger of H2 release during KOH etching rupturing large membranes and there is danger of membrane stiction during drying—especially for large-membrane (>100 microns-wide) structures. Membranes as large as 82 μm-wide (2 MHz resonant frequency in air) were successfully etched and released without problems. Etch-holes are sealed in (j) using low-stress PECVD TEOS which forms sealing plugs without coating CMUT gap. The gap would be coated if LPCVD were used, which has conformal coating. The TEOS is removed everywhere except the etch-hole region with a BOE etch step. This is done to prevent differing dielectric layers in the membrane as this could be a source of charge-trapping due to Maxwell Capacitor surface-charge accumulation at the dielectric interface. Additionally, there is no need to make the membrane any thicker than necessary, and a thick layer of TEOS is preferred to ensure sealing reliability and to maintain vacuum hermaticity long-term. CMUT cavity formation and sealing is complete after this step. Next, an access hole to the bottom electrode is formed in (k) by ICP-DRIE. This step may etch into the device layer (which is several microns thick) but this is inconsequential as the device layer is doped throughout the entire thickness. Finally metallization and patterning is performed in (l) to form the top membrane, top interconnects, top electrode bond-pad, and bottom-electrode bond-pad. With this design, wafer-level testing is easy to perform and the complexity of through-wafer-vias is avoided.

This process is similar to but different than the original sacrificial release fabrication schemes. Advantages of this method include an etch-stop for each important etching step, permitting high-etch-rate high-throughput ICP-DRIE to be used in an industrial fab without optimizing the etch-depths and without worrying about consequences of over-etching. This P-SOI-SR architecture also permits independent patterning of top and bottom electrodes, key to the success of the proposed device.

Using this P-SOI-SR process, we developed unique 2D arrays. Each element in the 2D array structure consists of 1×1 or 2×2 (or 3×3 etc.) CMUT cavities. Top electrodes are connected in strips orthogonal to bottom electrode strips as shown in FIG. 2. We call this structure design a Top Orthogonal-to-Bottom-Electrode Strip 2D CMUT array (TOBE-2D CMUT array). Materials used are labeled with reference characters as in FIG. 1.

Imaging Schemes

The TOBE-2D CMUT array offers some interesting possibilities for 3D imaging with low-channel count. We describe some proposed schemes and simulate their imaging performance using Field II simulation software, comparing their performance with mechanically wobbled linear arrays.

Scheme 1

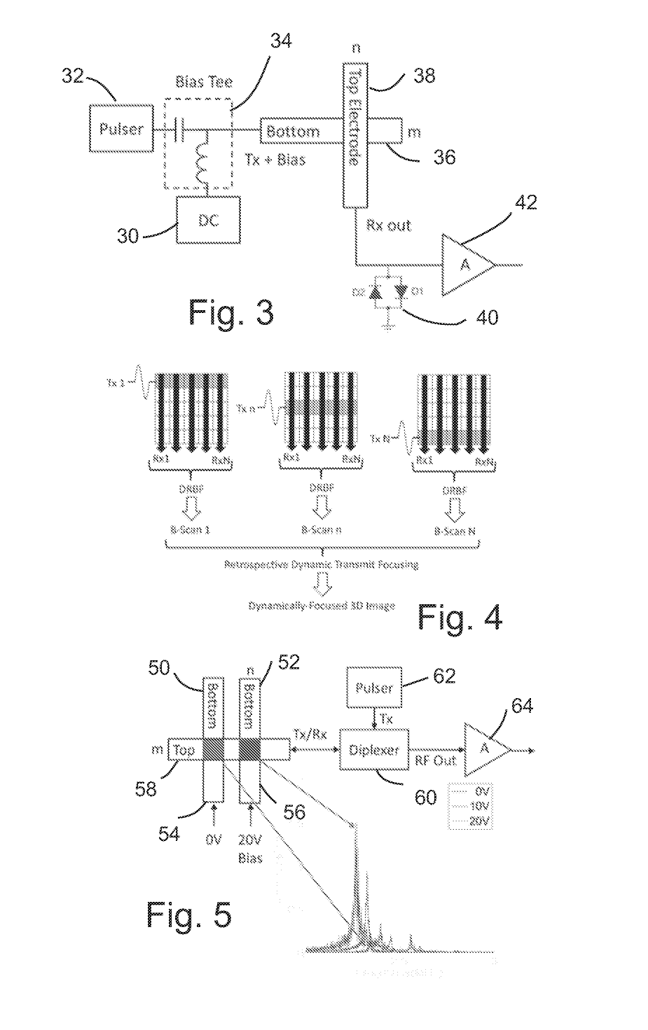

In scheme 1 we adopt a method proposed by J. Yen et al for 3D imaging using hybrid peizo-polymer/PZT arrays, where horizontal strips of PZT were used to transmit ultrasound, while vertical strips of PVDF were used to receive ultrasound. With this method, one-way focusing in the x-direction and one-way focusing in the y-direction could be accomplished. This scheme is implementable in straightforward way using our TOBE-2D-CMUTs, as illustrated in FIG. 3. In this scheme, which we call orthogonal one-way dynamic transmit-receive focusing (O1-DTRF) operation we apply bias voltages from DC source 30 and pulses from pulser 32 via bias tee 34 to the bottom electrode strips 36, while the top electrode 38 is maintained at ground via a diode pair 40 for electrical safety to prevent any voltages greater than 0.7V from contacting a human subject. While passivation layers can also be used, this scheme provides electrical safety, yet also permits small <0.7V receive signals be received via the top electrode and be amplified by amplifier 42. Alternate electronics may also be used to provide bias voltages and transmit-receive signals.

FIG. 4 is a schematic diagram showing Orthogonal One-way Dynamic Transmit-Receive Focusing (O1-DTRF). DRBF: Dynamic Receive Beamforming. Tx: Transmit. Rx: Receive. To form 3D images, bottom transmit strips are excited one at a time. Signals received by vertical top electrodes are received in parallel and beamformed to form B-scans using dynamic-receive beamforming. Once all transmit strips have been fired and an RF B-scan formed for each transmit event, the RF-B-scans can then be subjected to retrospective dynamic transmit-beamforming to produce an image focused in both x- and y-directions.

Using scheme 1, a 3D image may be formed using only N transmit events, and with N transmit channels and N-receive channels. One disadvantage of scheme 1 is that only one-way x-focusing and one-way y-focusing can be implemented. Additionally single-element control is not possible for more complex imaging schemes.

Scheme 2

In scheme 2, as shown in FIG. 5 bottom electrodes 50 and 52 provide bias-voltage control, bottom electrode 50 being supplied with first bias voltage 54 (0V in the embodiment shown) and bottom electrode 52 being supplied with second bias voltage 56 (20V in the embodiment shown), while top electrodes 58 are used for routing both transmit and receive signals, accomplished via a diplexer 60. A pulser 62 is connected to the diplexer, and an amplifier 64 is also connected to the diplexer. In this interfacing scheme, it is not possible to maintain the top electrode at ground potential using the present embodiment and a passivation layer will be required to provide electrical isolation for patient electrical safety. Even if the passivation layer is compromised, however, top electrode signals will contain single-cycle MHz-frequency burst signals with low-duty-cycle and low average power that should not pose a significant shock hazard to patients compared to lower frequencies. Alternate electronics may also be used to provide bias voltages and transmit-receive signals.

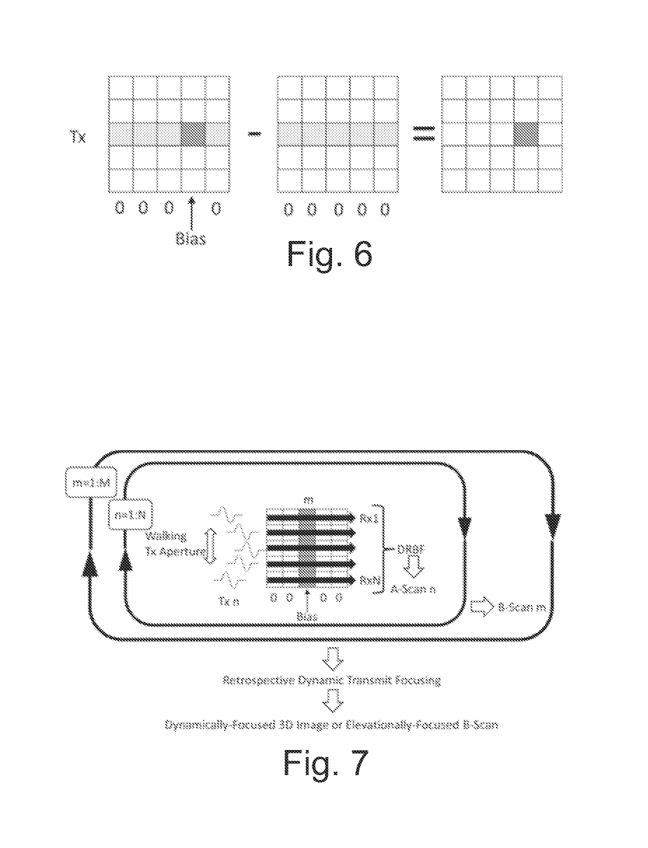

Scheme 2 makes unique use of the nonlinear transmit and receive response of CMUTs as a function of the bias voltage. With zero bias voltage, a given transmit pulse will produce negligible membrane oscillation, however, when a bias voltage is applied that is near the collapse voltage (for pre-collapse operation) or above the collapse voltage (for collapse-mode operation) the transmit response can be significantly higher. This is illustrated in FIG. 5, where real vibrometer testing data (to be discussed later) has been incorporated into the illustrative schematic. With the inter-connect methodology of scheme 2, it is thus possible to principally excite one element across a strip while other elements have negligible excitation. If we then consider two transmit events along the same strip: one with a bias applied to one vertical strip (with zero elsewhere) and another with zero bias on all strips, we may subtract the measured response from the two transmit events to effectively simulate a transmit event from a single element. This now is very powerful because groups of elements can be used to transmit and receive with different transmit or receive delays. Unlike the O1WTRF method of scheme 1 where only one-way focusing is possible in each direction, two-way focusing is possible in scheme 2, if we use an imaging pulse sequence pictorially illustrated in FIG. 6. We call this methodology orthogonal 2-way transmit-receive focusing (O2-DTRF). Enhanced resolution and lower sidelobes of O2-DTRF come at the expense of more transmit events (but similar to that used in a wobbled linear array probe) compared with O1-DTRF. Both schemes, however, require only N transmit channels and N receive channels. Multiplexing could further reduce the required channel count at the expense of requiring more transmit events, which could reduce frame-rate and lead to more motion artifacts. FIG. 7 is a schematic diagram showing Orthogonal 2-Way Dynamic Transmit-Receive Focusing using Scheme 2. Many additional imaging pulse- and bias-sequences may be implemented to perform imaging based on the proposed TOBE architecture and interfacing schemes.

Simulations

ANSYS Simulations

The membrane was modeled by 3-D elements (SOLID45) for simulation of resonant frequencies. For simulation of coupled electrical & structural forces, the membrane was meshed by SOLID95 elements, a higher-order version of SOLID45 elements. Electrostatic interactions for 3-D coupled-field simulations due to electrode biasing are added to the model using SOLID226. ANSYS simulations were used to estimate collapse and snapback voltages and to predict CMUT resonant frequencies. Designed devices have ˜5 MHz resonant frequency in air (data not shown).

Field II Simulations

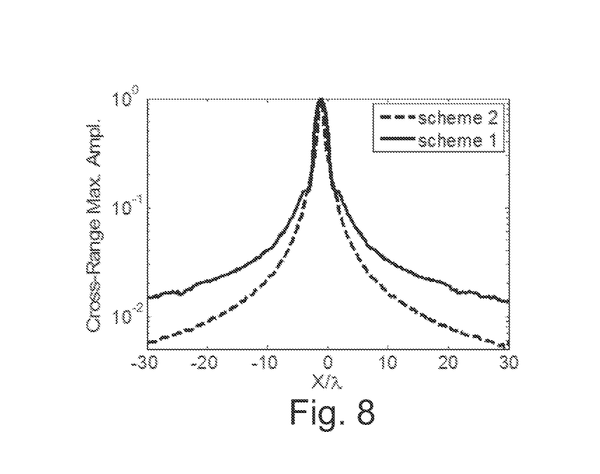

The ultrasound simulation software Field II was used to model the imaging performance of a 192-element by 192 element TOBE-2D-CMUT array. Element widths were 0.87 λ and kerfs were 0.087 λ in both x- and y-directions. A walking aperture rectilinear scanning approach with zero-steering angle was used with 64 active elements (assuming 3× MUX). The maximum amplitude projection C-scan image of two points located at an imaging depth of 104-wavelengths from the array surface after O1-DTRF processing using scheme 1 was obtained, and compared to a similar image obtained using O2-DTRF with scheme 2. FIG. 8. shows Cross-Range-Maximum-Amplitude point-spread function plots comparing imaging schemes 1 and 2 on a log-scale. FIG. 8 compares the point-spread function profiles of these two schemes, demonstrating improved sidelobe suppression and resolution with scheme 2.

Device and Experiments

A feasibility 7×7 mm TOBE 2D array was constructed with 64×64 elements, each composed of 2×2 CMUT cells, similar to FIG. 2 but with more elements. We characterize the frequency response of our CMUTs in air using a laser vibrometer system (Microsystem Analyzer MSA-500, Polytec Inc, Irvine, Calif., US). 3-axis stages were used to manipulate probes (Model SCA-50-4, Signatone, Corp. Gilroy, Calif., US). We applied a pseudo-random driving waveform with a mean of 0 and a standard deviation of 2.66V using a built-in function generator. A DC bias voltage, supplied from a programmable 0-72V DC power supply (Model 1787B, B&K Precision Corp., Yorba Linda, Calif., US) was added to the driving signals using a bias tee (Minicircuits, ZF).

TABLE 1
Comparison of TOBE CMUT imaging performance using schemes
1&2 compared with mechanically-wobbled linear arrays..

| | TOBE CMUT: | TOBE CMUT: | |
|---|---|---|---|
| | Scheme 1 | Scheme 2 | Wobbled Array |
| Top Electrode as Ground | YES | NO | YES |
| Mech. Scanning Required? | NO | NO | YES |
| # Tx Events for | N | 2N × M (scanline) | N × M |
| 3D | | Less for parallel | |
| | | &plane-wave imaging | |
| Lateral Focusing | Retrospective | Single Tx focus + | Single Tx focus + |
| | Dynamic Tx | DRF (two-way) | DRF (two-way) |
| | Focusing (one- | | |
| | way) | | |
| Elevational | DRF (one-way) | Retrospective | Fixed Tx/Rx focus |
| Focusing | | Dynamic Tx | (two-way, via |
| | | Focusing (one-way) | acoustic lens) |

TOBE CMUTs were fabricated using a modified sacrificial release process on a patterned SOI wafer. Two imaging schemes were proposed and imaging performance was simulated using FIELD II. Their relative merits are compared with each other and with wobbled linear arrays in Table 1.

Although the example given is of perpendicular electrode sets, which is preferred in practice, in principle so long as the electrodes are at a sufficient non-zero angle to yield a useful signal, the electrode sets need not be exactly orthogonal. There needs however to be some degree of orthogonality, that is, a non-zero angle between the electrode sets. It should also be mentioned that when we refer to electrodes or electrode strips, this may mean conductive material is routed between electrodes of individual elements. It may also be generalized to include active or passive elements used to route elements together. These strips need not be monolithic with the transducers and may be implemented using a number of means.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. An ultrasound array, comprising:
plural capacitive micromachined ultrasound transducers (CMUTs), each CMUT having a top electrode and a bottom electrode, the respective top electrodes of the CMUTs being connected in plural top electrode strips (TES), and the respective bottom electrodes of the CMUTs being connected in plural bottom electrode strips (BES), the BES being oriented at an angle to the TES, the angle being substantially different from zero;
transmit electronics connected to the TES or BES; and
receive electronics connected to the TES or BES.

2. An ultrasound array comprising:
plural ultrasound transducers, each ultrasound transducer having a top electrode and a bottom electrode, the respective top electrodes of the ultrasound transducers being connected in plural top electrode strips (TES), and the respective bottom electrodes of the ultrasound transducers being connected in plural bottom electrode strips (BES), the BES being oriented at an angle to the TES, the angle being substantially different from zero;
control electronics connected to the BES or to the TES, the control electronics controlling the response of the ultrasound transducers; and
transmit electronics and transmit electronics connected to the other of the TES or BES.

3. The ultrasound array of claim 2 in which the control electronics are configured to control the response of the ultrasound transducers by controlling bias and/or transient/modulation voltages.

4. The ultrasound array of claim 2 in which the ultrasound transducers are capacitive micromachined ultrasound transducers.

5. The ultrasound array of claim 4 in which the control electronics are configured to control the response of the ultrasound transducers by controlling bias voltages.
